(19) United States
(12) Patent Application Publication
(10) Pub. No.: US 2026/0153327 A1
(43) Pub. Date: Jun. 4, 2026

(54) REFLECTIVE DEVICE COMPRISING A DETECTOR, AND ASSOCIATED METHOD

(71) Applicant: COMMISSARIAT A L'ENERGIE ATOMIQUE ET AUX ENERGIES ALTERNATIVES, Paris (FR)

(72) Inventors: Laurent MOLLARD, Grenoble Cedex 09 (FR); Laurent FREY, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/941,024

(22) Filed: Nov. 8, 2024

(30) Foreign Application Priority Data
Nov. 9, 2023 (FR) 2312227

(51) Int. Cl. G01B 11/27; G01M 11/02; G02B 26/08

(52) U.S. Cl. CPC G01B 11/272; G01M 11/0207; G02B 26/0816

(57) ABSTRACT

A reflective device includes a partially transparent mirror configured to form a reflected beam by reflection of a part of an incident beam, and to transmit another part of the incident beam to form a transmitted beam. The reflective device further includes a detector module configured to measure at least one parameter associated with the transmitted beam, the at least one parameter being chosen from among a presence or an absence of the transmitted beam, a position of the transmitted beam, and a shape of the transmitted beam, and to determine an alignment state of the incident beam with the reflective device and/or a deformation of the mirror.

### TECHNICAL FIELD

The present invention relates to the field of reflective devices, intended to reflect an incident light beam to a target. It has a particularly advantageous application in the field of MEMS (electromechanical microsystems) micromirrors, in particular for LIDAR (light detection and ranging) and laser pointing applications, for example, for a beam focalisation in a given point of a scene.

### PRIOR ART

Reflective devices are used in numerous applications, in which it is sought to reflect an incident light beam to a given target.

For this, an incident light beam is emitted by a source to the reflective device having an at least partially transparent mirror. The mirror has a front face disposed so as to receive the incident light beam. The mirror is oriented with the source so as to form a beam reflected in the direction of the target.

For example, MEMS micromirrors are commonly used for LIDAR or laser pointing applications. The micromirrors can, for this, comprise an actuator module configured to make the micromirror pivot about at least one axis of rotation.

In LIDAR-type devices, micromirrors make it possible to scan a surface or a target with a light radiation for detection or imaging purposes. Typically, micromirrors are configured to oscillate along one or two axis/es of rotation, at a predetermined scanning frequency, so as to reflect an incident radiation along different directions.

The scanning frequency of micromirrors can vary from a few Hz to a few kHz, and their size can be around a few tens of micrometres to a few millimetres (for example, a few millimetres of diameter for disc-shaped micromirrors), and can, in particular, be between 500 μm and 10 mm.

FIGS. 1A and 1B illustrate, as an example, two reflective device 1′ architectures. In FIG. 1A, the device 1′ can comprise a first micromirror 10 and a second micromirror 10′, arranged to pivot respectively about a first axis of rotation X and a second axis of rotation Y not parallel to one another. In particular, these two micromirrors 10, 10′ are arranged such that a light beam 20 emitted by a light source 2 is reflected by the first micromirror 10 in the direction of the second micromirror 10′ which itself reflects it in the direction, for example, of a screen or of a target 3. The rotation of each of the micromirrors 10, 10′ about their respective axis of rotation thus makes it possible to perform a scanning of a surface with the reflected light beam 21, for example, for imaging or detection purposes.

In FIG. 1B, the device 1′ can comprise one single micromirror 10 mounted pivoting about two axes of rotation X and Y not parallel to one another. The rotation of this micromirror 10 about one and the other of the two axes X, Y thus makes it possible to scan the surface of a screen or of a target 3 by means of a reflected light beam 21 coming from a light source 2 and reflected by this micromirror 10.

In these devices, it is important to ensure a correct alignment between the source of the beam and the micromirror, in order to correctly orient the reflected beam. Furthermore, these devices are often exposed to thermal and mechanical stresses being able to impact their operation, and in particular, the properties of the reflected beam.

A reflective device comprising a partially transparent mirror and means for absorbing a beam transmitted by the rear face of the mirror to limit the thermal heating are, in particular, known from document EP3726268A1. This solution however remains limited to ensure a correct operation of the reflective device.

An aim of the present invention is therefore to propose a solution improving the reliability of the reflection by a partially reflective reflective device.

Other aims, features and advantages of the present invention will appear upon examining the description below and the accompanying drawings. It is understood that other advantages can be incorporated.

### SUMMARY

To achieve this aim, according to a first aspect, a reflective device is provided, which is more specifically intended to reflect an incident light beam to a target. The reflective device comprises a partially transparent mirror having a front face disposed so as to receive the incident light beam and a rear face opposite the front face, the mirror being configured to form a beam reflected by reflection of a part of the incident beam, and to transmit another part of the incident beam by the rear face to form a transmitted beam.

Advantageously, the reflective device further comprises a detector module facing the rear face of the mirror. The detector module is configured to measure at least one parameter associated with the transmitted beam, the at least one parameter being chosen from among:
a presence or an absence of the transmitted beam,
a position of the transmitted beam,
a shape of the transmitted beam,
   and to determine an alignment state of the incident beam with the reflective device and/or a deformation of the mirror.

Thus, the beam transmitted by the partially transparent mirror can be used to ensure the correct alignment of the incident beam with the mirror, and in particular, the correct alignment between the source and the mirror, and/or detect a possible deformation of the mirror, while enabling the reflection of the beam reflected to the target.

If, following an impact for example, the mirror and/or the source are moved, the incident beam can no longer be reflected by the mirror or its position can be changed. The reflective device makes it possible to detect this and optionally consider corrective actions. When the reflective device is exposed to thermal stresses, the reflective device makes it possible to determine a deformation of the mirror, in particular leading to a change of focalisation of the transmitted beam.

The reflective device therefore enables a real-time measurement of the alignment of the laser and of the mirror and/or of the deformation of the mirror, which lead to a modification of the reflected beam. It is therefore possible to continuously ensure that the reflected beam actually goes in the desired direction. The reliability of the reflection of the incident beam to a target is therefore improved. The reflective device is therefore particularly advantageous for applications in which there is no return from the target, i.e. that it is difficult or impossible to ensure that the reflected beam correctly reaches the target.

A second aspect relates to a method for measuring the alignment of an incident beam and/or a mirror deformation implementing the reflective device according to the first aspect, comprising:
an emission of the incident beam from a light source to the reflective device,
a measurement, by the detector module, of the at least one parameter associated with the beam transmitted by the mirror, the at least one parameter being chosen from among:
   a presence or an absence of the transmitted beam,
   a position of the transmitted beam,
   a shape of the transmitted beam,
a determination of the alignment state of the incident beam with the reflective device and/or of the deformation of the mirror comprising:
   if the parameter measured by the detector module is an absence of the transmitted beam and/or a position of the transmitted beam different from a defined position, a determination of an incorrect alignment of the incident beam, and/or
   if the parameter measured by the detector module is a shape of the transmitted beam different from a defined shape, a determination of a deformation of the mirror.

It is therefore understood that the measuring method also enables a real-time measurement of the alignment of the source and of the mirror and/or of the deformation of the mirror. The method therefore enables a reliability of the reflection of the incident beam.

### BRIEF DESCRIPTION OF THE FIGURES

The aims, objectives, as well as the features and advantages of the invention will best emerge from the detailed description of an embodiment of the latter, which is illustrated by the following accompanying drawings, in which:

FIGS. 1A and 1B represent two examples of reflective devices of the prior art.

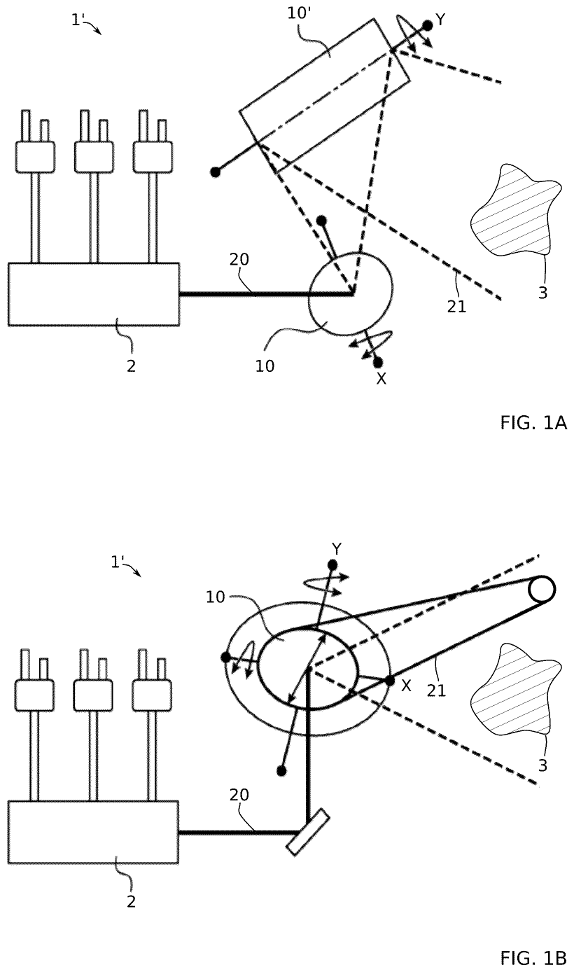

FIGS. 2A to 2C represent cross-sectional views of three examples of reflective devices according to three examples of embodiments of the invention.

FIG. 3 represents a cross-sectional view of the reflective device during a determination of a misalignment between the source and the mirror, according to an example of an embodiment.

FIGS. 4A and 4B represent a cross-sectional view of the reflective device during a determination of a deformation of the mirror, according to an example of an embodiment.

FIG. 5A represents a perspective view of an example of a reflective device in which the mirror is mounted pivoting along an axis of rotation.

FIG. 5B represents a top view of an example of a reflective device in which the mirror is mounted pivoting along two axes of rotation.

FIG. 6 represents a cross-sectional view of a reflective device comprising a focalisation lens, according to an example of an embodiment.

FIGS. 7A and 7B represent a cross-sectional view of two particular examples of a reflective device.

The drawings are given as examples and are not limiting of the invention. They constitute principle schematic representations intended to facilitate the understanding of the invention and are not necessarily to the scale of practical applications. In particular, the relative dimensions of the layers and elements of the reflective device are not representative of reality.

### DETAILED DESCRIPTION

Before starting a detailed review of embodiments of the invention, optional features are stated below, which can optionally be used in association or alternatively.

According to an example, the detector module is configured to determine the alignment state of the incident beam with the reflective device and/or a deformation of the mirror according to:
If the Parameter Measured by the Detector Module Is an Absence of the transmitted beam and/or a position of the transmitted beam different from a defined position, an incorrect alignment of the incident beam is determined by the detector module, and/or
if the parameter measured by the detector module is a shape of the transmitted beam different from a defined shape, a deformation of the mirror is determined by the detector module.

Thus, the reflective device can make it possible to independently determine an incorrect alignment of the incident beam and/or a deformation of the mirror, according to the nature of the measured information.

According to an example, the reflective device further comprises a support and an actuator module configured to pivot the mirror about at least one axis of rotation with respect to the support, in which the detector module is secured to the support. The reflective device is thus particularly adapted to MEMS mirror applications. With the detector module being secured to the support, determining an incorrect alignment of the incident beam and/or a deformation of the mirror can be made independently from the angular position of the mirror. Indeed, the transmitted beam will not be impacted by the angular position of the mirror during its rotation.

According to an example, the detector module has a time resolution greater than or equal to a characteristic time of misalignment of the incident beam. For this, for example, the detector module has an acquisition frequency greater than or equal to a vibration frequency of the source.

According to an example, the mirror comprises:
a metal reflective layer comprising at least one opening and/or having a thickness chosen to transmit the other part of the incident beam to form the transmitted beam, and/or
a Bragg stack comprising at least one so-called “basic” Bragg stack comprising two layers having distinct refraction indices.

The Bragg stack makes it possible to modulate the transmitted part and the reflected part of the beam according to the features of the layers composing it and of the basic stack number. Furthermore, the reflection and transmission properties can be modulated according to the wavelength of the incident beam.

According to an example, the basic Bragg stack comprises two dielectric and/or semiconductive layers.

According to an example, the basic Bragg stack comprises an amorphous silicon layer and a silicon oxide layer.

According to an example, the detector module is disposed at a non-zero distance from the rear face of the mirror, said distance being between 1 μm and 15 cm, preferably between 0.5 cm and 15 cm.

According to an example, the device comprises a mechanical support layer having a front face and a rear face opposite the front face.

According to an example, the mirror sits on top of, by its rear face, the front face of the mechanical support layer.

According to an example, the mechanical support layer is silicon-based, preferably monocrystalline silicon-based.

According to an example, the detector module comprises a single-element detector.

According to an example, the detector module comprises a pixelated array, preferably pixelated along two dimensions. The detection of a positional offsetting of the transmitted beam, as well as the deformation of the transmitted beam is thus facilitated. Furthermore, a quantitative measurement can be obtained, improving the measurement of the alignment of the incident beam and/or of the deformation of the mirror. This further facilitates the implementation of a subsequent corrective action.

According to an example, the reflective device further comprises an optical element, for example, a lens, configured to focalise the transmitted beam on the detector module. The focalisation of the transmitted beam on the detector can thus be modulated, and in particular, in synergy with the distance of the detector module with respect to the lens. The resolution of the detection of the alignment state and/or of the deformation of the mirror can thus be improved.

According to an example, the mirror extends into a main extension plane, over at least one millimetric dimension, for example, a diameter, preferably of between 500 μm and 10 mm, preferably between 500 μm and 5 mm.

According to an example, the device is a LIDAR reflective device.

According to another example, the device is a laser pointing system.

According to these two examples, the reflective device further comprises, in particular, a support and an actuator module configured to pivot the mirror about at least one axis of rotation with respect to the support, the detector module being secured to the support.

According to an example, the device comprises the light source configured to emit the incident beam.

According to an example, the light source is an infrared source.

According to an example, the light source is configured to emit the incident beam with a wavelength greater than or equal to 900 nm, for example, 905 nm or 1550 nm.

According to an example, the light source is a laser source.

According to an example, the incident beam and the reflected beam propagate along propagation directions which are distinct from one another.

According to an example, the transmitted beam is a non-diffracted beam. According to an example, the transmitted beam and the incident beam propagate along a substantially identical propagation direction.

According to an example, the method comprises the reflection of a part of the incident beam by the mirror to form the reflected beam, in particular, to a target.

According to an example, the method comprises a transmission of another part of the incident beam by the mirror, to form the transmitted beam.

According to an example, the reflection of the incident beam by the mirror to form the reflected beam is at least partially simultaneous to the measurement by the detector module, of the at least one parameter associated with the transmitted beam.

According to an example, the method further comprises a correction of at least one from among the position of the light source and the position of the mirror if, during the determination of an alignment state of the incident beam with the reflective device and/or a deformation of the mirror, an incorrect alignment of the incident beam is determined. The reliability of the reflective device can thus be improved by correcting the alignment defect of the source or by compensating this alignment defect with the position of the mirror.

According to an example, the reflective device comprising an actuator module configured to pivot the mirror about at least one axis of rotation, and the detector module secured to the mirror comprising a two-dimensional pixelated array:
the determination of an alignment state of the incident beam with the reflective device and/or a deformation of the mirror comprises a determination of an offsetting between the position of the transmitted beam and the defined position, and
the correction of the position of the mirror comprises a modification of the angular pivoting range of the mirror according to said offsetting.

The misalignment of the source can thus be determined quantitatively. According to this data, the modification of the angular pivoting range of the mirror makes it possible to compensate for this misalignment in a simplified manner, and without having to review the alignment of the source. This is particularly advantageous for a correction during the use of the reflective device, without requiring a dismounting and/or a complex realignment.

According to an example, the method comprises an emission of an alert and/or a thermal dissipation action at the mirror if, during the determination of an alignment state of the incident beam with the reflective device and/or a deformation of the mirror, a deformation of the mirror is determined. The reliability of the reflection is thus improved either by the emission of an alert to the user, or by action on a cause of the deformation by limiting the thermal heating of the mirror.

By a substrate, a layer with the basis of a species A, this means a substrate, a layer comprising this species A only or this species A and optionally other species.

By microelectronic device, this means any type of device produced with microelectronic means. These devices include, in particular, in addition to devices with a purely electronic purpose, micromechanical or electromechanical devices (MEMS, NEMS, etc.), as well as optical or optoelectronic devices (MOEMS, LED, etc.).

It is specified that in the scope of the present invention, the thickness of a layer or of a substrate is measured along a direction perpendicular to the surface along which this layer or this substrate has its maximum extension. The thickness is thus taken along a direction perpendicular to the main faces of the substrate on which the different layers rest.

It is specified that, in the scope of the present invention, the terms “on”, “sits on top of”, “covers”, “underlying”, “opposite” and their equivalents do not necessarily mean “in contact with”. Thus, for example, the arrangement of a first layer on a second layer, does not compulsorily mean that the two layers are directly in contact with one another, but means that the first layer covers at least partially the second layer by being either directly in contact with it, or by being separated from it by at least one other layer or at least one other element.

By a parameter “substantially equal to/greater than/less than” a given value, this means that this parameter is equal to/greater than/less than the given value, plus or minus 10% of this value. By a parameter “substantially between” two given values, this means that this parameter is, as a minimum, equal to the lowest given value, plus or minus 10% of this value, and as a maximum, equal to the greatest given value, plus or minus 10% of this value.

In the present patent application, the term “secured” used to qualify the connection between two parts means that the two parts are linked/fixed against one another, according to all degrees of freedom, except for if it is explicitly specified differently. For example, if it is indicated that two parts are secured in translation along a direction X, this means that the parts can be movable against one another, possibly according to several degrees of freedom, excluding the freedom in translation along the direction X. In other words, if a part is moved along the direction X, the other part makes the same movement.

In the detailed description below, use can be made of terms such as “horizontal”, “vertical”, “longitudinal”, “transverse”, “upper”, “lower”, “top”, “bottom”, “front”, “rear”, “inner”, “outer”. These terms must be interpreted relative in relation with the normal position of the reflective device and the propagation of the light beams, and in particular, of the incident light beam, relative to the reflective device.

Also, a system will also be used, the longitudinal direction of which corresponds to the axis X, the transverse or right/left direction corresponds to the axis Y and the vertical direction of the bottom/top or also front/rear corresponds to the axis Z.

For the purpose of the present disclosure, the expression “A and/or B” means (A), (B), or (A and B). For the purpose of the present disclosure, the expression “A, B and/or C” means (A), (B), (C), (A and B), (A and C), (B and C), or (A, B and C).

The reflective device 1 and the method for measuring the alignment of an incident beam 20 and/or a mirror 10 deformation are now described according to several examples of embodiments.

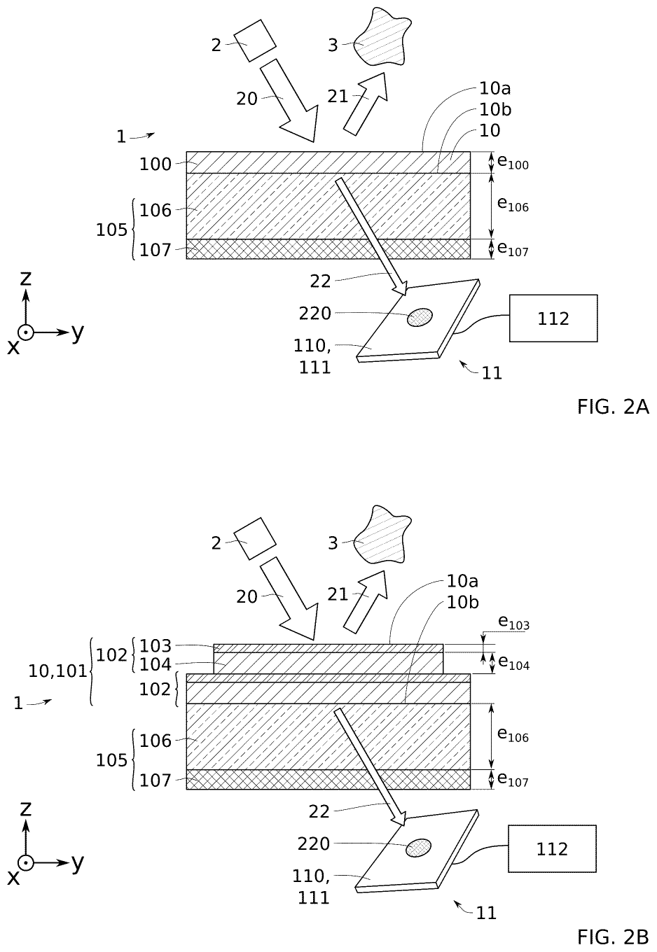

As, for example, FIGS. 2A to 2C illustrate, the reflective device 1 is intended to reflect an incident light beam 20 to form a reflected beam 21 propagating in a determined direction, typically to a target 3. For this, the incident light beam 20 can be emitted by a source 2. The source 2 is more specifically aligned with the reflective device 1 such that, after reflection on the reflective device 1, the reflected beam 21 reaches the target 3.

The light source 2 can be an infrared source. According to an example, the light source 2 is configured to emit the incident beam with a wavelength greater than or equal to 900 nm, for example, 905 nm or 1550 nm, propagating into the air. Preferably, the light source 2 is a laser source.

The reflective device 1 comprises a mirror 10 having a front face 10a and a rear face 10b opposite the front face 10a. The incident beam 20 propagates from the source 2 to the mirror 10, and more specifically to its front face 10a. The reflected beam 21 then propagates from the front face 10a of the mirror 10 to the target 3. The mirror 10 is more specifically a flat mirror. It is noted that the size of the incident beam 20 on the mirror 10 can be larger, than the size of the mirror 10, or smaller.

During a misalignment of the source 2 and of the mirror 10, it is understood that the incident beam 20 can no longer be reflected on the mirror 10, or the reflected beam 21 can be deviated from its course initially provided and miss the target 3. This can occur, for example, in case of impact. Moreover, a modification of the flatness of the mirror 10 can lead to a change in the focalisation of the reflected beam 21. The reflected beam 21 can thus not correctly reach the target 3. This can occur, for example, during a thermal stress following a heating of the mirror 10 or of an impact or a mechanical urging on the structure, for example, during vibration. The incident beam 20 can indeed heat the mirror 10, which will impact its reflection properties. This can, in particular, be observed when the incident beam is an infrared beam, and/or when the source 2 is a laser source.

In order to make the reflection reliable by the reflective device 1, the mirror 10 is configured to reflect a part of the incident beam 20 to form the reflected beam 21, and to transmit another part of the incident beam 20 by the rear face 10b of the mirror to form a transmitted beam 22. The mirror 10 is therefore partially transparent. It has a reflective component and a transmission component. Preferably, the mirror 10 is configured to reflect between 75% and 99.9% of the incident beam 20. The mirror 10 can be configured to transmit between 24.5% and 0.03% of the incident beam 20.

The reflective device 1 uses the transmitted beam 22 in order to determine an alignment state of the incident beam 20 with the reflective device 1 and/or a deformation of the mirror 10. For this, the reflective device 1 comprises a detector module 11 disposed facing the rear face 10b of the mirror 10. The detector module 11 is therefore placed below the mirror 10 in the reflective device 1, with respect to the propagation of the incident beam 20. The detector module 11 is disposed so as to receive the transmitted beam 22 at least when the incident beam 20 is correctly aligned with the reflective device 1, and in particular, the mirror 10.

The detector module 11 is configured to measure at least one parameter associated with the transmitted beam 22. This/these parameter(s) is/are chosen from among:
a presence or an absence of the transmitted beam 22,
a position 220 of the transmitted beam 22,
a shape 222 of the transmitted beam 22.

According to this/these parameter(s), the detector module 11 can determine an alignment state of the incident beam 20 with the reflective device 1 and/or a deformation of the mirror 10. The reflective device 1 thus makes it possible to independently determine these states, and this, continuously during its use.

The detector module 11 can comprise a detector 110, 111. The detector module can further comprise analysis means 112, for example, by at least one processor. The analysis means 112 can comprise instructions making it possible to carry out the steps of analysing data and/or determining an alignment state of the incident beam with the reflective device and/or a deformation of the mirror. These instructions can make it possible that the alignment state of the incident beam 20 with the reflective device 1 and/or the deformation of the mirror 10 are determined from the measured parameter. These analysis means 112 can further comprise instructions to perform the prior analysis of a datum acquired by a detector to determine the parameter associated with the transmitted beam 22.

According to an example, the detector module 11 can comprise a single-element detector 110 and/or a detector comprising a pixelated array 111, for example, according to the two dimensions X, Y. In the figures, it is noted that this pixelated array 111 is presented in a non-limiting manner in perspective, in particular, for legibility and explanation purposes. By single-element detector 110, this means that the detector is configured to measure the light intensity of the transmitted beam 22 without dedicated means to know its position on the detector 110. This is therefore not a pixelated detector. For example, the single-element detector is a single-detector, or also single-pixel, InGaAs, or silicon-based or made-of-silicon CMOS detector.

For a 1550 nm radiation, an InGaAs-based or made-of-InGaAs detector 110, 111 will be favoured. For a 905 μm radiation, a silicon-based or made-of-silicon detector 110, 111 can be considered, for example, a CMOS detector. A CMOS detector is however generally limited in terms of acquisition frequency of around 1 kHz to 10 kHz. This can be limiting with respect to the pivoting speed of the mirror 10, as discussed in more detail below. There are scientific cameras with acquisition frequencies of several tens of kHz, they are however expensive. The detector 110, 111 can be of a size less than or equal to that of the mirror 10 the plane (X, Y). For example, the detector 110, 111 can extend in projection into the plane (X, Y) only over a fraction of the surface of the mirror taken in the same plane. The detector 110, 111 can extend into a main extension plane substantially parallel to the main extension plane of the mirror 10. Alternatively, it can be provided that the detector 110, 111 is positioned obliquely with respect to the mirror 10.

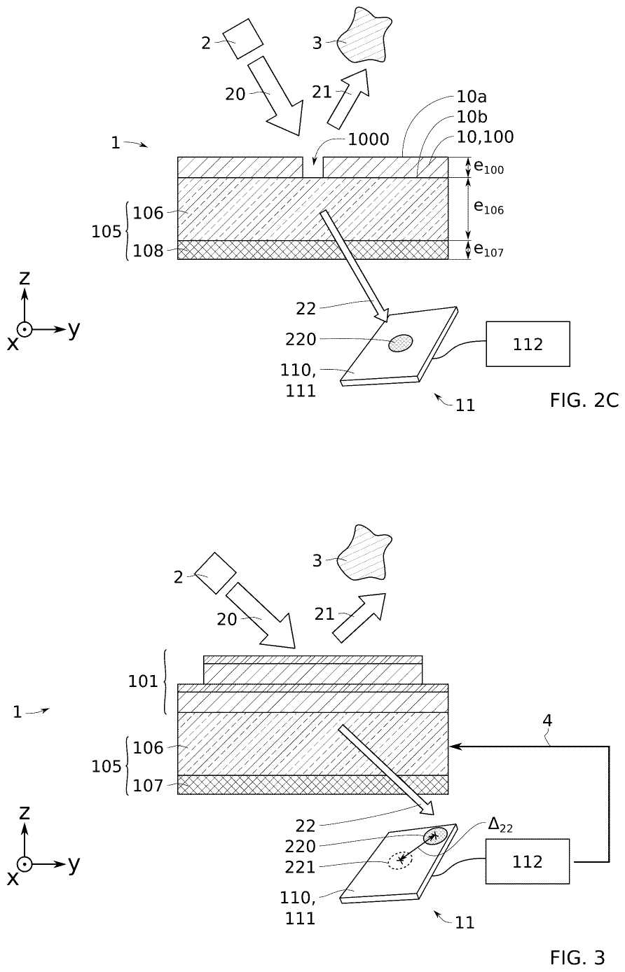

The transmitted beam 22 typically propagates substantially in the same direction with respect to the incident beam 20. Equivalently, the transmitted beam 22 is not substantially deviated by the mirror 10. Equivalently, it is considered that the deviation of the beam 22 during its transmission by the mirror 10 is negligible as regards the effects of the misalignment of the source 2 and/or of the deformation of the mirror 10. In any case, a possible deviation of the transmitted beam 22 by the mirror (for example, in case of lack of parallelism between the two surfaces of the mirror 10 or in a lesser measure due to the thickness of the mirror), can form a low deviation limit of the measurable incident beam 20. As illustrated in FIG. 3, if the incident beam 20 is misaligned with respect to its provided position (illustrated for comparison in FIGS. 2A to 2C), thus the propagation direction of the transmitted beam 22 is consequently modified. The misalignment of the incident beam 20, and in particular, the misalignment between the source 2 and the mirror 10 can be a rotation (which modifies the angle of incidence of the incident beam 20 on the mirror 10) or a translation (which does not modify the angle of incidence of the incident beam 20 on the mirror), or a combination of both.

The transmitted beam 22 can no longer be detected by the detector module 11, or as illustrated, the position 220 of the transmitted beam on the detector module can be modified. An incorrect alignment of the incident beam 20 and therefore an incorrect alignment of the source and of the reflective device 1 can be determined.

When the detector module 11 comprises a single-element detector, the measured parameter will preferably be a presence or an absence of the transmitted beam 22. When the detector module 11 comprises a pixelated array 111, a more quantitative measurement of the position 220 of the transmitted beam can further be obtained. For example, as illustrated in FIG. 3, an offsetting Δ₂₂ of the position 220 of the transmitted beam can be measured with respect to a defined position 221, for example, its initial position.

When an incorrect alignment of the incident beam 20 is detected, a corrective action 4 can thus be implemented. The reflective device 1, for example, the mirror 10, and/or the source 2, can be realigned until again obtaining the detection of a transmitted beam 22 on the detector module 11. Alternatively complementarily, the reflective device 1, for example, the mirror 10, and/or the source 2 can be realigned so as to compensate for the offsetting Δ₂₂ of the position 220 of the transmitted beam. A more particular example is described below in relation to a rotating, pivotable mirror.

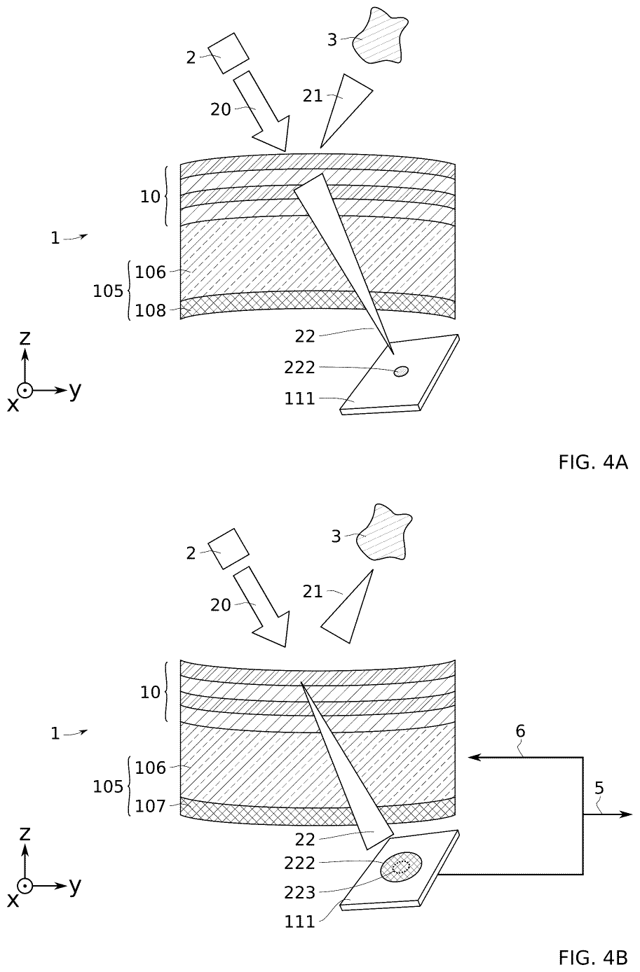

During a deformation of the mirror 10, the focalisation state of the reflected 21 and transmitted 22 beams can be modified. These beams 21, 22 can, for example, become more convergent or more divergent than the incident beam 20, which is generally infinitely focalised. The shape 222 of the transmitted beam 22 on the detector module 11 can be modified, as illustrated, for example, in FIGS. 4A and 4B.

When the detector module 11 comprises a single-element detector, a deformation of the mirror 10 can be determined according to the measured light intensity. With the shape of the transmitted beam 22 on the detector module 11 being modified, an intensity variation can indeed be measured. Preferably, to determine a deformation of the mirror 10, the detector module 11 comprises a pixelated array 111. The area of the spot formed by the transmitted beam 22 on the pixelated array 111 can be modified according to the focalisation of the transmitted beam 22 can be determined with respect to a defined shape 223, for example, its initial shape.

When a deformation of their mirror 10 is detected, an alert 5 can be emitted, for example, to the user. Thus, the user is alerted of a decreased reliability of the reflection of the incident beam 20 to the target 3. Alternatively or complementarily, a thermal dissipation action 6 can be performed at the mirror 10. For example, the source 2 can be switched off in order to dissipate the heating of the mirror 10. A person skilled in the art can absolutely consider other actions making it possible to compensate for and/or limit the deformation of the mirror 10.

The defined position 221 and/or the defined shape 223 can be defined during a calibration step, for example, before the reflection to the targeted target 3.

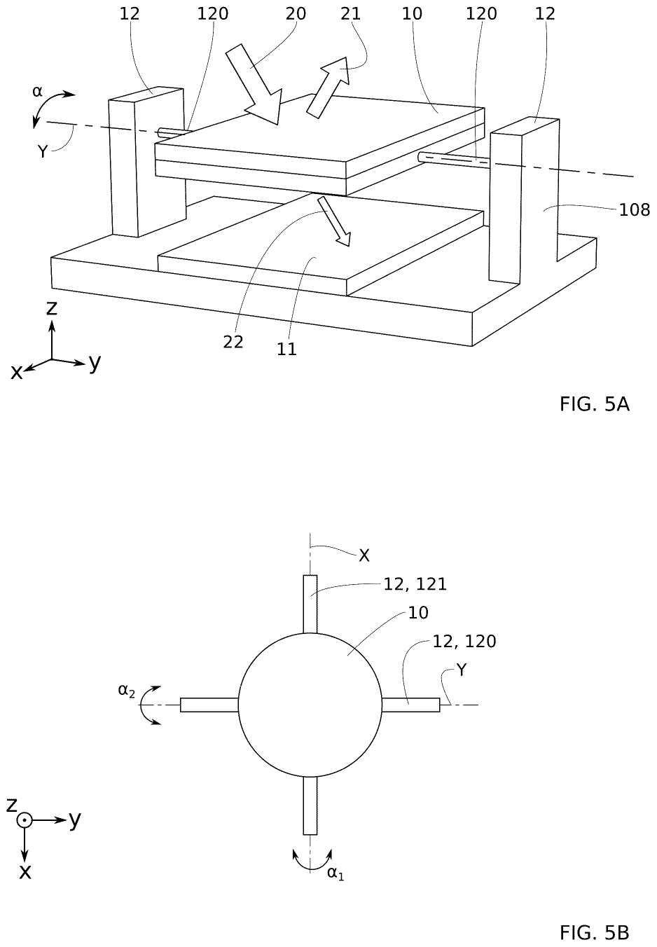

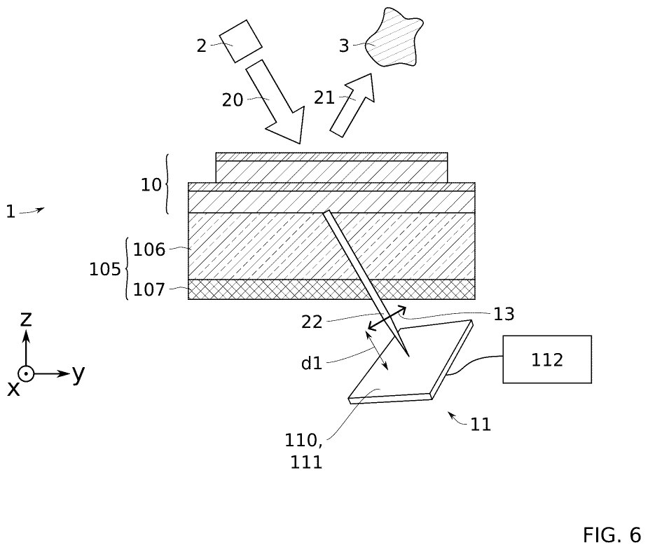

According to a particular example, illustrated by FIGS. 5A and 5B, the mirror 10 is configured to pivot about at least one axis of rotation X, and preferably about axes of rotation X and Y, for example, over an angular interval α, α1, α2. The axes X, Y are thus non-parallel to one another, and preferably perpendicular. Preferably, at least one axis of rotation is parallel to, and preferably located in, a plane of the front face 10a of reflection of the mirror 10. The mirror 10 can, in particular, be a MEMS-type micromirror. The reflective device 1 is thus particularly adapted to LIDAR or laser pointing applications. Preferably, the mirror 10 is configured to pivot about two axes of rotation X and Y.

When the mirror moves angularly (in X and/or in Y), the position of the transmitted beam 22 does not substantially move, except for misalignment of the source and of the mirror 10 or modification of the shape of the mirror 10.

With the mirror 10 being pivotable, it is possible to play on the angular position of the mirror 10 to compensate for the misalignment of the incident beam 20. For example, the angular interval of rotation can be adapted to compensate for this misalignment. The angular interval of rotation α, α1 and/or α2 can, in particular, be adapted according to the measured offsetting Δ₂₂.

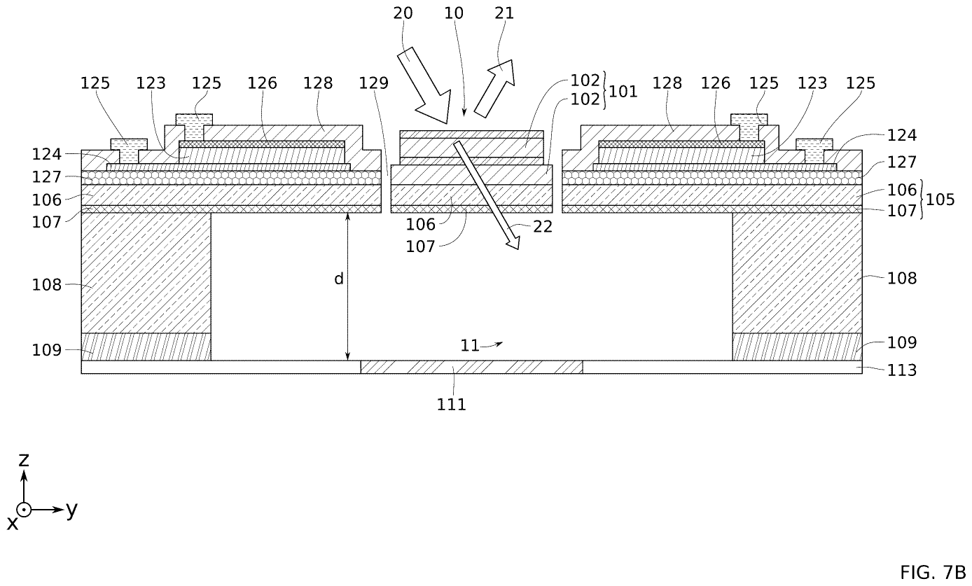

According to an example, the mirror 10 can be disposed on a support 108 configured to remain fixed during the movement of the mirror 10. This support is represented, as an example, in FIGS. 5A and 7A, 7B. The detector module 11 is preferably secured to the support 108, preferably at least in rotation along the directions X and Y. The detector module 11 can be secured to the support 108 according to all degrees of freedom. It can be provided that the detector module 11 is free in translation with respect to the support 108, along the direction Z. Thus, the detector module 11 is independent from the movement of the mirror 10. The propagation of the transmitted beam 22 will not therefore be substantially impacted by the rotating position of the mirror 10.

The alignment state of the incident beam 20 and/or the deformation of the mirror 10 can therefore be determined independently from the rotating position of the mirror 10. It is thus not necessary to take the measurement, to return the mirror 10 into a setpoint position to take the measurement. The measurement of the alignment of an incident beam 20 and/or of a deformation of the mirror 10 can therefore be taken continuously during the use of the reflective device 1, including for a rotating, moving mirror 10.

The detector module 11 and the support 108 can be disconnected from one another, as for example illustrated in FIG. 7A. The detector module 11 and the support 108 can be secured to one another through a support 113, as for example illustrated in FIG. 7B.

The reflective device 1 can further comprise an actuator module 12 configured to make the mirror pivot about the axis/axes of rotation X, Y, for example, by actuator arms 120. The actuator module 12 can comprise at least one actuator chosen from among: an electrostatic actuator, a magnetic actuator, a piezoelectric actuator, a thermal actuator. Preferably, the actuator module 12 comprises at least one piezoelectric actuator 120. The actuator module 12 has, for example, two actuators 120, one on a so-called “rapid” axis of rotation, and one on a so-called “slow” axis of rotation. The actuator module 12 can have movement frequencies of substantially 10 Hz on the slow axis and substantially 1 kHz on the rapid axis.

Preferably, the detector module 11 has a time resolution greater than or equal to a characteristic time of misalignment of the incident beam. It can, for example, be provided that a source 2, for example, a laser source, vibrates at a given frequency (for example, linked to vibrations of the poorly compensated structure). This movement can thus be monitored over the detector module 11. The transmitted beam 22 can move with respect to the assembly formed by the mirror 10 and the detector module 11. The detector module 11 can detect this real-time movement when its acquisition frequency is greater than or equal to the movement of the impact point of the transmitted beam 22 on the detector module 11.

According to an example, the pivoting speed of the mirror 10 is typically between 1 Hz and 50 kHz. This value can, in particular, be according to the size of the mirror and to the targeted application. For example, for a mirror 2 mm in diameter, the slow and rapid frequencies will be respectively from 10 Hz to 40 Hz and from 200 Hz to 1000 Hz. For smaller mirrors (for example, around 0.5 mm in diameter), the rapid frequencies can go up to 20 kHz, for example.

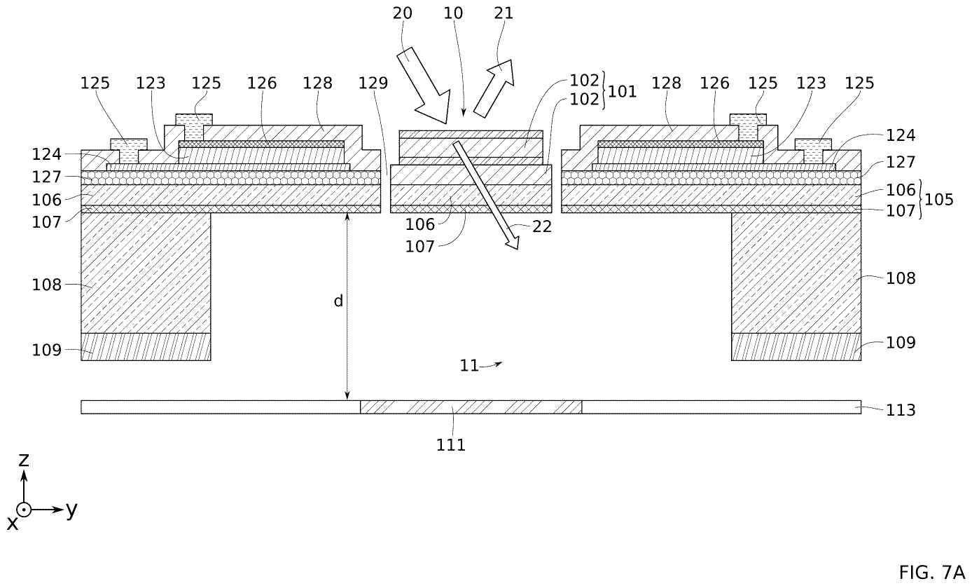

According to an example illustrated in FIG. 6, the reflective device 1 can comprise an optical element 13, for example, a lens 13, configured to modulate the focalisation of the transmitted beam 22 on the detector module 11. Thus, the resolution of the position measurement 220 and/or of the shape 222 of the transmitted beam 22 can be improved, and this, in particular when the detector module comprises a pixelated array 111. For this, the distance d₁ between the lens 13 and the detector 110, 111 can, for example, be adapted.

The reflective device 1 is now described in more detail, element by element, according to several examples of embodiments.

The mirror 10 is partially transparent. For this, the mirror 10 can comprise at least one metal reflective layer 100 configured to allow a part of the incident beam 20 pass to form the transmitted beam 22. For this, and as illustrated in FIG. 2A, the metal reflective layer 100 can have a thickness e100 configured to allow a part of the incident beam 20 pass. It is understood that this thickness can vary according to the nature of the metal used. For example, the metal reflective layer 100 is gold-based. According to an example, the metal reflective layer 100 has a thickness e100 substantially less than or equal to 100 nm.

Alternatively complementarily, and as illustrated in FIG. 2C, the mirror 10 can comprise an opening 1000 configured to transmit a part of the incident beam 20 to form the transmitted beam 22. The thickness e100 of the metal reflective layer 100 can thus be greater than the range above. The analysis of the deformation of the mirror 10 can however be limited in the case of a simple opening 1000, without any component transmitted through the reflective material of the mirror 10.

According to a preferable example, for example, illustrated in FIGS. 2B, 3 to 4B, 6 and 7A and 7B, the mirror 10 comprises a Bragg stack 101, the Bragg stack comprising at least one basic Bragg stack 102. By “Bragg stack”, this means a periodic succession of transparent layers, and different refraction indices. A basic Bragg stack comprises a stack of two dielectric and/or semiconductive layers 103, 104. In the Bragg stack, in a known manner, the optical index difference between these layers is used to reflect the desired wavelength.

The nature of the layers 103, 104 can be chosen according to the wavelength of the incident beam 20, to modulate the transmitted part and the reflected part of the beam. The number of basic Bragg stacks can further be chosen to modulate the transmitted part and the reflected part of the incident beam 20. For example, the number of basic Bragg stacks 102 can make it possible to modulate the quantity of light transmitted to not dazzle the detector module 11 while ensuring a threshold which is sufficient for detection. The limitation of the number of basic Bragg stacks further makes it possible to reduce the mechanical stresses imposed on the mirror, and thus limit the risk of a mechanical deformation of the mirror. According to an example, the Bragg stack 101 comprises between one and five, preferably between one and three, basic Bragg stacks 102.

Preferably, the thickness of the layers 103, 104 is chosen such that these are so-called “λ/4” layers, i.e. that the product of the thickness of a layer by the optical index of the layer is substantially equal to one quarter of the wavelength in the vacuum. This makes it possible to obtain reflecting constructive interferences, and therefore maximise the reflection of the incident reflection 20, at a given number of layers, the rest starting to transmit.

As an example, when the radiation is in the infrared range, and more specifically, of wavelength equal to 1550 nm, the basic Bragg stack 102 can comprise a silicon dioxide-based or made-of-silicon oxide layer 104 of a thickness of substantially 305 nm (the refraction index of which at 1550 nm equals 1.45) topped by an amorphous silicon-based or made-of-amorphous silicon layer 103 of a thickness of 110 nm (the refraction index of which at 1550 nm equals 3.42).

According to this configuration, a Bragg stack 101 only comprising one single basic Bragg stack 102, will have, for an incidence of 20°, a reflection coefficient equal to 82.4% and a transmission coefficient equal to 17.6% facing a light radiation of wavelength equal to 1550 nm. For an incidence of 45°, the reflection coefficient is 80.9% and the transmission coefficient is 19.1%. Moreover, this stack will not be absorbent and will have an almost zero heating. The risk of a heating of the mirror 10 is therefore limited.

Still according to this configuration, a Bragg stack 101 comprising two basic Bragg stacks 102 will have, for a radiation incidence of 45°, a reflection coefficient equal to 96.4% and a transmission coefficient equal to 3.6% facing a light radiation of wavelength equal to 1550 nm. Moreover, this stack will only be slightly or not absorbent and will have an almost zero heating.

According to an example, the mirror 10 extends into a main extension plane (X, Y), over at least a millimetric dimension, for example, a diameter, preferably of between 500 μm and 10 mm, preferably between 500 μm and 5 mm.

According to an example, the mirror 10 can be formed on a mechanical support layer 105 with the basis or made of, for example, a semiconductive or dielectric material.

The distance between the detector module 11 and the mirror 10 can be modified to optimise the measurement. As illustrated, for example, in FIGS. 7A and 7B, the detector module 11, and in particular, the detector 110, 111 can be disposed at a non-zero distance d from the rear face 10 b of the mirror 10. This distance d can be between 1 μm and 15 cm, preferably between 0.5 cm and 15 cm. According to an example, the detector module 11 is disposed at a distance from the rear face of the mechanical support layer 105. According to an alternative example, the detector module 11 is disposed on the rear face of the mechanical support layer 105.

Choosing the material of the mechanical support layer 105 can, for example, be according to the wavelength λ. As an example, the absorption coefficient of a mechanical support layer 105 is negligible, even zero, for wavelengths greater than 1250 nm. The mechanical support layer 105 can comprise one or more layers 106, 107. As, for example, illustrated in FIGS. 2A to 2C, the mechanical support layer 105 can comprise a silicon-based of made-of-silicon layer 106, for example, monocrystalline silicon, for example, of a thickness e₁₀₆ substantially between 1 μm and 100 μm, and preferably equal to 20 μm. The mechanical support layer 105 can further comprise a silicon oxide-based or made-of-silicon oxide layer 107, for example, coming from a buried oxide layer. The, for example, silicon oxide layer 107, can have a thickness substantially between 0.2 μm and 2 μm.

An example of the architecture of the reflective device 1 is now described in reference to FIGS. 7A and 7B. The mechanical support layer 105 can come from a semiconductor-on-insulator substrate, and more specifically, silicon-on-insulator. This substrate can comprise, for example, a monocrystalline silicon layer 106 covering a silicon dioxide layer 107 formed on a monocrystalline silicon substrate 108.

The Bragg stack 101 can sit on top of the mechanical support layer 105. The Bragg stack represented in this figure comprises, in particular, two basic Bragg stacks 102 each comprising a 305 nm thick silicon dioxide layer, and a 110 nm thick amorphous silicon layer.

The reflective device further comprises a first protective layer 127, for example, silicon-based or made of silicon, of a lower electrode 124, of a piezoelectric layer 123 (for example, a PZT), of an upper electrode 126, and of a second protective layer 128, for example, silicon oxide-based or made of silicon oxide. The reflective device 1 can further comprise reconnections 125, for example, gold-based or made of gold.

The reflective device 1 can further comprise a mask 109, for example, a hard mask. This mask 109, which can, in particular, be silicon oxide-based or made of silicon oxide, can come from the manufacturing of the reflective device to enable the release of the mirror 10 by etching from a rear face of the SOI substrate.

The mirror 109 can be partially surrounded by trenches, passing through the mechanical support layer 105. It is therefore understood that the mechanical support layer 105 of the mirror 10 can come from the same substrate as the support 108. It is considered that the mechanical support layer 105 of the mirror 10 cannot be rotatably secured to the support 108, in particular, due to the release of the mirror 10 and of the trenches 129.

An example of the method for manufacturing the reflective device is, for example, given in document EP3726268A1. The detector module 11 can be positioned facing the rear face 10b of the mirror 10 by packaging methods known to a person skilled in the art.

The invention is not limited to the embodiments described above and extends to all the embodiments covered by the invention. The present invention is not limited to the examples described above. Plenty of other variants of embodiments are possible, for example, by combining features described above, without moving away from the scope of the invention. For example, the illustrated examples implementing a Bragg stack are transposable to a mirror having a partially reflective metal layer. A particular architecture of the reflective device 11 is given as an example. The reflective device can be implemented on any other type of reflective device having a partially transparent mirror. Furthermore, the features described relative to an aspect of the invention can be combined with another aspect of the invention.

1. A reflective device configured to reflect an incident light beam to a target, comprising
a partially transparent mirror having a front face disposed so as to receive the incident light beam and a rear face opposite the front face, the mirror being configured to form a reflected beam by reflection of a part of the incident light beam, and to transmit another part of the incident light beam by the rear face to form a transmitted beam, and
a detector module disposed facing the rear face of the mirror so as to receive the transmitted beam at least when the incident light beam is correctly aligned with the reflective device, the detector module being configured to
measure at least one parameter associated with the transmitted beam, the at least one parameter being chosen from among:
a presence or an absence of the transmitted beam,
a position of the transmitted beam, and
a shape of the transmitted beam, and
determine an alignment state of the incident light beam with the reflective device and/or a deformation of the mirror.

2. The reflective device according to claim 1, wherein the detector module is configured to determine the alignment state of the incident light beam with the reflective device and/or a deformation of the mirror according to:
if the parameter measured by the detector module is an absence of the transmitted beam and/or a position of the transmitted beam different from a defined position, an incorrect alignment of the incident light beam is determined by the detector module, and/or
if the parameter measured by the detector module is a shape of the transmitted beam different from a defined shape, a deformation of the mirror is determined by the detector module.

3. The reflective device according to claim 1, further comprising a support and an actuator module configured to pivot the mirror about at least one axis of rotation with respect to the support, wherein the detector module is secured to the support.

4. The reflective device according to claim 3, wherein the detector module has a time resolution greater than or equal to a characteristic time of misalignment of the incident light beam, for example, the detector module has an acquisition frequency greater than or equal to a vibration frequency of a source emitting the incident light beam (20).

5. The reflective device according to claim 1, wherein the mirror comprises:
a metal reflective layer comprising at least one opening and/or having a thickness chosen to transmit another part of the incident light beam to form the transmitted beam or
at least one Bragg stack comprising two layers having distinct refraction indices.

6. The reflective device according to claim 1, wherein the detector module is disposed at a non-zero distance from the rear face of the mirror, the distance being between 1 μm and 15 cm.

7. The reflective device according to claim 1, wherein the detector module comprises a single-element detector.

8. The reflective device according to claim 1, wherein the detector module comprises a pixelated array along two dimensions.

9. The reflective device according to claim 1, further comprising an optical element configured to focalise the transmitted beam on the detector module.

10. The reflective device according to claim 1, further comprising a support and an actuator module configured to pivot the mirror about at least one axis of rotation with respect to the support, the detector module being secured to the support, and the device being a LIDAR reflective device.

11. The reflective device according to claim 1, further comprising a support and an actuator module configured to pivot the mirror about at least one axis of rotation with respect to the support, the detector module being secured to the support, and the device being a laser pointing system.

12. A method for measuring alignment of the incident light beam and/or the mirror deformation implementing the reflective device according to claim 1, comprising:
emitting the incident light beam from a light source to the reflective device,
measuring, using the detector module of the at least one parameter associated with the transmitted beam by the mirror, the at least one parameter being chosen from among:
a presence or an absence of the transmitted beam,
a position of the transmitted beam, and
a shape of the transmitted beam,
determining the alignment state of the incident light beam with the reflective device and/or the deformation of the mirror, wherein
if the parameter measured by the detector module is an absence of the transmitted beam and/or a position of the transmitted beam different from a defined position, determining an incorrect alignment of the incident light beam, and/or
if the parameter measured by the detector module is a shape of the transmitted beam different from a defined shape, determining a deformation of the mirror.

13. The method according to claim 12, further comprising correcting at least one from among the position of the light source and the position of the mirror if, during the determination of an alignment state of the incident light beam with the reflective device and/or a deformation of the mirror, an incorrect alignment of the incident light beam is determined.

14. The method according to claim 13, wherein
the reflective device comprises an actuator module configured to pivot the mirror about at least one axis of rotation, and the detector module is secured to the mirror comprising a two-dimensional pixelated array,
determining an alignment state of the incident light beam with the reflective device and/or a deformation of the mirror comprises determining an offset between the position of the transmitted beam and the defined position, and
correcting the position of the mirror comprises modifying an angular pivoting range of the mirror according to the offset.

15. The method according to claim 12, comprising emitting an alert and/or a thermal dissipation action at the mirror if, during determining the alignment state of the incident light beam with the reflective device and/or a deformation of the mirror, a deformation of the mirror is determined.

16. The device according to claim 4, wherein the detector module has an acquisition frequency greater than or equal to a vibration frequency of a source emitting the incident light beam.

17. The reflective device according to claim 6, wherein the distance is between 0.5 cm and 15 cm.
